(19) United States
(12) Patent Application Publication
(10) Pub. No.: US 2022/0113731 A1
(43) Pub. Date: Apr. 14, 2022

(54) Systems And Methods For Assisting A Delivery Robot

(71) Applicant: Ford Global Technologies, LLC, Dearborn, MI (US)

(72) Inventors: Kenneth Yesh, Dearborn, MI (US); Justin Miller, Berkley, MI (US); Shankar Mohan, Ann Arbor, MI (US)

(73) Assignee: Ford Global Technologies, LLC, Dearborn, MI (US)

(21) Appl. No.: 17/068,007

(22) Filed: Oct. 12, 2020

(51) Int. Cl. G05D 1/02; G06K 9/00; G06K 9/62; G06Q 10/08

(52) U.S. Cl. CPC G05D 1/0212; G06K 9/00664; G06K 9/6202; G05D 2201/0216; G05D 1/028; G06Q 10/083; G05D 1/0246

(57) ABSTRACT

This disclosure is generally directed to using a building security system to provide assistance to a delivery robot. In one example implementation, a communication system provided in the delivery robot communicates with the building security system to obtain information pertaining to a terrain between the autonomous vehicle and a package drop-off spot at the building. The information may be provided in the form of an image captured by a camera located on the premises of the building. In one case, the delivery robot may identify a landmark in the image and use the landmark to navigate to the package drop-off spot. In another case, the delivery robot may use the image to generate a route map for traveling to the drop-off spot. In yet another case, the delivery robot may match and/or compare the image to a reference image or a topographical map to navigate to the package drop-off spot.

### BACKGROUND

Autonomous vehicles, which are often referred to by various other names, such as robotic vehicles, unmanned aerial vehicles, terrestrial robots, and delivery robots, have of late become the focus of numerous developmental efforts. A number of these developmental efforts have been directed at using robots for delivering various types of packages to homes and businesses. A robot that is used to deliver packages, which may be referred to as a delivery robot, typically includes navigation and sensing equipment that enables the delivery robot to safely negotiate obstacles that may be encountered when the delivery robot is moving to deliver a package.

Typically, the sensing equipment is activated when the delivery robot starts moving towards a package drop-off spot, such as, for example, from a sidewalk towards a door of a house. The type of obstacles that are detected by the sensing equipment and the speed at which each obstacle is detected is generally dependent on the level of sophistication and capability of the sensing equipment. When the sensing equipment is relatively unsophisticated, the delivery robot may spend a considerable amount of time to detect obstacles, travel around the obstacles, and reach the drop-off spot. When doing so, the delivery robot may start moving forward along a first travel route towards the drop-off spot. The delivery robot may encounter a first obstacle on the first travel route that forces the robot to back up (or turn around) and seek an alternative route. The delivery robot may then start moving along a second travel route towards the drop-off spot and encounter a second obstacle that forces the robot to once again back up (or turn around) and seek another alternative path forward, and so on. Such maneuvers can be quite time-consuming and can adversely impact package delivery efficiency. Speed of delivery, which determines how many packages can be delivered within a certain amount of time, is a very important factor for most delivery services, such as, for example, FedEx®, UPS®, and USPS®. It is therefore desirable to provide systems and methods that address at least some such traditional shortcomings and improve the efficiency of delivery robots.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an example system where a building security system provides assistance to a delivery robot in accordance with an embodiment of the disclosure.

FIG. 2 shows an example configuration of the system illustrated in FIG. 1.

FIG. 3 shows some example components that may be included in a navigation system of a delivery robot in accordance with an embodiment of the disclosure.

FIG. 4 shows some example components that may be included in a computer system of the building security system in accordance with an embodiment of the disclosure.

### DETAILED DESCRIPTION

### Overview

In terms of a general overview, the disclosure is directed to systems and methods related to using a building security system to provide assistance to a delivery robot. In one example, a communication system provided in the delivery robot communicates with the building security system to obtain information pertaining to a terrain between the autonomous vehicle and a package drop-off spot at the building. The information may be provided in the form of an image captured by a camera located on the premises of the building. In one case, the delivery robot may identify a landmark in the image and use the landmark to navigate to the package drop-off spot. In another case, the delivery robot may use the image to generate a route map for traveling to the drop-off spot. In yet another case, the delivery robot may match and/or compare the image to a reference image or a topographical map to navigate to the package drop-off spot.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words, terms, and phrases that are used in this disclosure must be interpreted as referring to various objects and actions that are generally understood in various forms and equivalencies by persons of ordinary skill in the art. For example, the phrase “delivery robot” as used herein may be referred to alternatively in general parlance as a “self-driven vehicle” or a “robotic vehicle.” As another example, words such as “data” and “information” and words such as “path” and “route” may be used interchangeably in this disclosure and should be understood as being equivalent to each other in the context of the description. The word “building” as used herein refers to any structure such as, for example, a residence, a house, a business facility, or a commercial establishment. The word “image” as used herein refers to any of various kinds of media such as, for example, a photograph captured by a conventional camera, a digital image produced by a digital camera, or a graphical/digitized representation of a view or an object. Furthermore, it should be understood that the word “example” as used herein is intended to be non-exclusionary and non-limiting in nature.

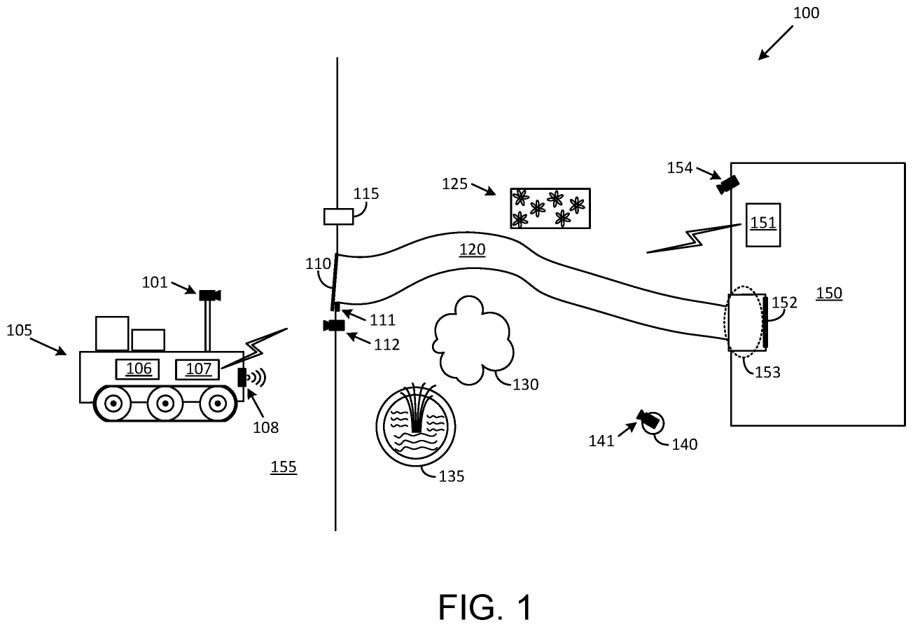

FIG. 1 illustrates an example system 100 where a building security system 151 provides assistance to a delivery robot 105 in accordance with an embodiment of the disclosure. The delivery robot 105 may be any of various types of autonomous or semi-autonomous terrestrial robots used to deliver various types of items such as such as, for example, a pizza, an item of mail, a grocery item, or a package. The delivery robot 105 may include various components such as a navigation system 106, a communication system 107, and various sensors and/or detectors. The sensors and/or detectors can include devices such as, for example, a video camera, a digital camera, an infrared camera, an object detector, a distance sensor, a proximity sensor, an audio sensor, a light detection and ranging (LIDAR) device, a radar device, and/or a sonar device that are communicatively coupled to the navigation system 106. The signals provided by the various sensors and/or detectors, such as, for example an image provided by a camera 101, or a signal provided by an ultrasonic sensor 108, may be evaluated by the navigation system 106 for determining a travel route for the delivery robot 105 when moving on the premises of the building 150.

The navigation system 106 may receive navigation assistance from a building security system 151 in accordance with the disclosure. The navigation assistance provided by the building security system 151 can complement information received by the various sensors and detectors on the delivery robot 105, and minimizes an amount of time taken by the delivery robot 105 to make a delivery.

In addition to minimizing delivery time, the navigation assistance provided by the building security system 151 may also help the delivery robot 105 avoid accidents that may possibly occur if the delivery robot 105 depended solely on the sensors and detectors. For example, the navigation assistance provided by the building security system 151 can assist the navigation system 106 of the delivery robot 105 to plot a travel route that avoids travelling over a lawn area and risking damage to the turf and vegetation on the lawn area. As another example, the navigation assistance provided by the building security system 151 may assist the delivery robot 105 avoid certain types of obstacles that may be undetectable or difficult to detect by the detectors and sensors. One example of such an obstacle is a portion of ground that is sodden or contains loose gravel, thereby posing traction issues for the wheels of the delivery robot 105.

The communication system 107 is configured to permit the delivery robot 105 to wirelessly communicate with the building security system 151 for obtaining assistance, such as navigation assistance to traverse the terrain between the sidewalk 155 and the building 150. In the example illustration shown in FIG. 1, the terrain may include a pathway 120 and various objects such as a mailbox 115, a tree 130, a fountain 135, a flower bed 125, and a fixture 140 (a pole or a gazebo, for example) on which is mounted a security camera 141. A conventional delivery robot that is unassisted by the building security system 151 may typically start moving from the sidewalk 155 and on to the lawn without having any information about any potential obstacles in its path. For example, the conventional delivery robot may first move forward and either detect a low wall of the fountain 135 (using an object sensor), or collide with the wall of the fountain 135 if the object sensor is unable to detect the low wall. The conventional delivery robot may then go around the fountain 135 before sensing (or colliding with) the tree 130. The conventional delivery robot may then attempt to take an alternative route by moving towards the pathway 120. Thus, the movement of the conventional delivery robot would involve a trial-and-error approach to reach the building 150, thereby expending precious delivery time and risking damage to the delivery robot and/or package transported by the conventional delivery robot.

In an example embodiment, the delivery robot 105 uses a route map that is generated by the navigation system 106, either independently or by using assistance provided by the building security system 151, and uses the route map to travel from the sidewalk 155 to the building 150.

In some instances, the communication system 107 of the delivery robot 105 sends out a wireless request to the building security system 151 to obtain information pertaining to the premises on which the building 150 is located, and other information that may be pertinent for use by the delivery robot 105 when delivering a package. The building security system 151 may respond to the request by providing an image captured by a security camera such as, for example, the security camera 154 or the security camera 141. In some cases, more than one image and/or a live camera feed, may be provided so that the delivery robot 105 can obtain views of the premises from different angles. In some other cases, the information may be provided by the building security system 151 in other formats such as in the form of a topographic map, a terrain map, a graphical representation of the premises and/or the building 150, a digital rendering of the building 150, and/or a digital rendering of an object on the premises (the fountain 135 having the low wall, for example).

The navigation system 106 of the delivery robot 105 may evaluate the image (or images/video clip) in different ways. In one example scenario, the navigation system 106 may evaluate an image to select and/or to identify a landmark located on the premises. The landmark can be any object that the navigation system 106 can use to determine a position/orientation of the delivery robot 105 with respect to the building 150. Some example landmarks can include the mailbox 115, the fountain 135, the fixture 140, and one or more structural features of the building 150 (window, door, garage, corner, etc.).

After identifying the landmark, the navigation system 106 may use the information derived by evaluating the image to determine a travel route from a current location of the delivery robot 105 (on the sidewalk 155) to a package drop-off spot (front porch 153 of the building 150, for example). In one case, the package drop-off spot may be designated by a resident/owner of the building 150 and the building security system 151 provides the delivery robot 105 details about the package drop-off spot. In another case, the delivery robot 105 may independently determine the package drop-off spot such as, for example, a spot that is under surveillance by a security camera, so as to prevent theft of the package.

In another approach, the navigation system 106 may select one or more landmarks in an image provided by the building security system 151 and identify the selected landmarks in a reference image that is either stored in the delivery robot 105, or obtained by the delivery robot 105 via a network such as the Internet. A similar procedure may be applied to any of various other types of media that the building security system 151 may provide to the delivery robot 105 such as, for example, a topographic map, a terrain map, a graphical representation of the premises and/or the building 150, a digital rendering of the building 150, and/or a digital rendering of an object on the premises.

Identifying the selected landmarks in the reference image (or other media) may be carried out by using a comparison procedure where the reference image is compared and/or matched to the image provided by the building security system 151. The comparison/matching procedure can include actions such as overlaying, aligning, rotating, and/or editing (changing size, correcting artifacts, etc.) of one or both images. After identifying the landmark, the navigation system 106 may use the reference image (in original form or in modified form) to generate and/or determine a travel route from a current location of the delivery robot 105 to a package drop-off spot. Using the reference image to do so, can include actions such as identifying a location of the delivery robot 105 in the reference image, orienting the delivery robot 105 in an appropriate direction, and moving along the defined travel route.

The travel route may be defined in a manner that allows the delivery robot 105 to circumvent objects such as the tree 130 and the fountain 135, by using information provided by the building security system 151. The information may include, for example, various rules and guidelines that the resident/owner of the building 150 may specify for delivering of packages by the delivery robot 105. The rules and guidelines may include, for example, a rule forbidding the delivery robot 105 from traveling on a lawn on the premises, and another rule that restricts a speed at which the delivery robot 105 can move on the premises. The guideline may include, for example, an advisory that advises the delivery robot 105 to transmit a text message or email to the resident/owner of the building 150 when the delivery robot 105 enters the premises.

When traveling along the travel route, the navigation system 106 may use the reference image (in original form or in modified form), and signals from the sensors and/or detectors to detect and avoid obstacles. In some cases, the navigation system 106 may define a travel route that avoids certain obstacles automatically, such as by defining the travel route to coincide with the pathway 120.

In the example shown in FIG. 1, entry to the pathway 120 is via a gate 110 that is controlled by the building security system 151. The delivery robot 105 may request the building security system 151 to open the gate 110 to allow the delivery robot 105 passage into the premises. The request may be provided, for example, in the form of an audio message transmitted by a transponder of the delivery robot 105 to a microphone in the gate operating system 111, and/or a text message transmitted by the delivery robot 105 to the building security system 151. The building security system 151 may respond to the request by demanding some form of identification or authorization from the delivery robot 105.

The delivery robot 105 may display any of various forms of identification or authorization to a gate camera 112 that can be a part of the gate operating system 111. For example, the delivery robot 105 may display an identifier such as a label on a package. The label may include various items such as, for example, a name of an individual, an address, a bar code, a QR code, and/or a numerical code that can be captured by the gate camera 112 and inspected by the building security system 151. In some cases, an address on the package may correspond to a different building. The building security system 151 may then inform the delivery robot 105 that the address is incorrect and entry into the premises of the building 150 is not permitted.

In some scenarios, the delivery robot 105 may provide a form of authentication such as an entry pass, a vehicle identification (registration, license, etc.), a code word, or a code phrase, in lieu of displaying the label on the package. The code word or code phrase may be provided beforehand by the resident/owner of the building 150 to an administrator of the delivery service operating the delivery robot 105. The code may be, for example, a number, an alphanumeric sequence, a password, or a code phrase. In some other scenarios, the delivery robot 105 may use a lighting system of the delivery robot 105 (an LED, for example) to emit a unique sequence of light flashes towards the gate camera 112. The unique light flashing sequence can represent a code that is recognizable by the building security system 151 as a valid form of identification for the delivery robot 105.

Upon successful authentication, the building security system 151 may activate a latch in the gate operating system 111 to open the gate 110. The building security system 151 may then cooperate with the delivery robot 105 when the delivery robot 105 passes through the gate 110, to use the camera 101 of the delivery robot 105 for monitoring an area around the delivery robot 105. The monitoring may be carried out by the building security system 151 for security reasons, such as to ensure that no miscreant is entering the premises along with the delivery robot 105. In some implementations, the building security system 151 may provide navigation assistance to the delivery robot 105 only after the delivery robot 105 has entered the premises and stopped near the gate 110 on the pathway 120.

Authentication procedures and navigation assistance such as the example ones described above, may also be executed in accordance with the disclosure when the delivery robot 105 has arrived at the gate 110 to pick up a package. The package may have been left at a package pick-up spot (such as the front porch 153 of the building 150, or on the pathway 120) by the resident/owner of the building 150. The authentication procedure and navigation assistance provided by the building security system 151 ensures that the delivery robot 105 is authorized to pick up the package from the package pick-up spot. The procedures described with respect to the gate 110 may also be applied to a door in the building 150, such as, for example, a front door 152.

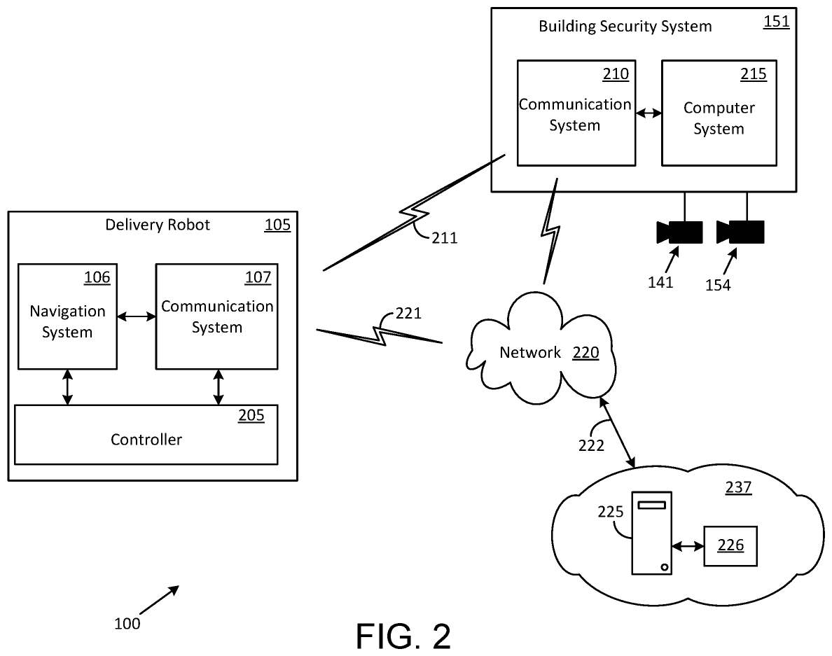

FIG. 2 shows an example configuration of some components of the system 100 in accordance with an embodiment of the disclosure. The delivery robot 105 can include the communication system 107, the navigation system 106, and a controller 205 that is communicatively coupled to the communication system 107 and the navigation system 106 for controlling various operations of the delivery robot 105. The controller 205 may use signals provided by the navigation system 106 to operate a drive mechanism (motor, battery, brakes, etc.) and a steering mechanism for moving the delivery robot 105, such as from the sidewalk 155 to the package pick-up spot inside the premises of the building 150.

The communication system 107 communicates with the building security system 151 by using a wireless link 211 that may be implemented using any of various forms of wireless technologies such as, for example, cellular communications, Wi-Fi communications, and optical communications. The communication system 107 may also communicate with the building security system 151 and/or cloud storage 237 via a wireless link 221 and a network 220. Cloud storage 237 may include various components such as, for example, a server computer 225 coupled to a storage device 226. The wireless link 221 may be implemented by using any of various forms of wireless technologies such as, for example, the ones used for the wireless link 211.

The network 220 may include any one, or a combination of networks, such as a local area network (LAN), a wide area network (WAN), a telephone network, a cellular network, a cable network, a wireless network, and/or private/public networks such as the Internet. For example, the network 220 may support communication technologies such as TCP/IP, Bluetooth, cellular, near-field communication (NFC), Wi-Fi, Wi-Fi direct, machine-to-machine communication, and/or man-to-machine communication. The communication link 222 that supports communications between the server computer 225 and the network 220 may incorporate one or more of various types of wired and/or wireless technologies used for communications.

The building security system 151 can include a communication system 210 and a computer system 215. The communication system 210 may be used to communicate with the communication system 107 in the delivery robot 105 and/or the server computer 225. The computer system 215 of the building security system 151 performs various functions associated with securing the premises of the building 150 such as, for example, evaluating real-time images or video received from monitoring devices such as the security camera 141, the security camera 154, and the gate camera 112. The computer system 215 of the building security system 151 also provides assistance to the delivery robot 105 in accordance with the disclosure. For example, an image obtained from the security camera 141 and/or the security camera 154 may be provided to the delivery robot 105 for determining a travel route. The assistance may be provided to the delivery robot 105 subject to various rules and conditions. For example, the image obtained from the security camera 141 and/or the security camera 154 may be provided to the delivery robot 105 only when the building security system 151 receives authorization to do so. The authorization may be provided to the building security system 151 in various ways and at various times.

In one example scenario, the building security system 151 may obtain authorization from cloud storage 237. The authorization may be stored in cloud storage 237 by a delivery company that operates the delivery robot 105 or a resident/owner of the building 150. The building security system 151 may retrieve and examine the authorization instructions when the delivery robot 105 sends out a request to the building security system 151 for entering the premises of the building 150. The authorization instructions may include details such as, for example, package identification, time of delivery, and addressee, so that the building security system 151 may verify these details when the delivery robot 105 displays a package to the gate camera 112.

Entities such as a resident/owner of the building 150 may store various other types of information in cloud storage 237 such as, for example, instructions, guidelines, rules, and restrictions that the delivery robot 105 has to abide by (stay off the lawn, stay away from the flower bed 125, etc.). The building security system 151 may retrieve these instructions from cloud storage 237 on as as-needed basis, or for storing in a database in the building security system 151. The instructions may then be provided by the building security system 151 to the delivery robot 105.

Information stored in cloud storage 237 and or the database the building security system 151 can further include items such as a topographic map, a terrain map, a graphical representation of the premises and the building 150, a digital rendering of the building 150, and a digital rendering of an object on the premises. The items may be provided by the building security system 151 to the delivery robot 105 in response to a request from the delivery robot 105.

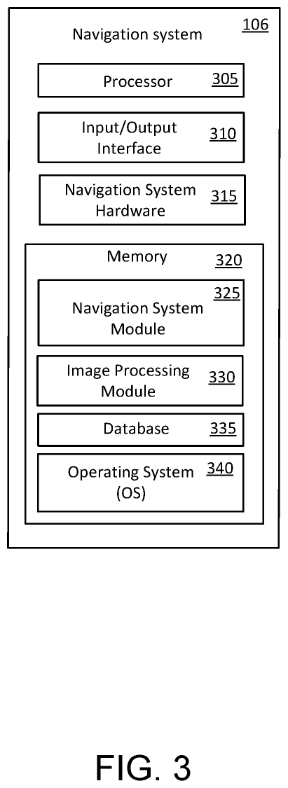

FIG. 3 shows some example components that may be included in the navigation system 106 of the delivery robot 105 in accordance with an embodiment of the disclosure. The navigation system 106 may include various components such as a processor 305, an input/output interface 310, navigation system hardware 315, and a memory 320. The input/output interface 310 can be used to allow various types of signals and information to pass into, or out of, the navigation system 106. For example, the input/output interface 310 may be used by the navigation system 106 to receive signals and data from various sensors and detectors of the delivery robot 105. Thus, the navigation system 106 can obtain images from the camera 101 and/or signals from the ultrasonic sensor 108. As another example, the input/output interface 310 may be used by the navigation system 106 to receive various types of commands and signals from the controller 205. The commands and/or signals may be associated with operating the delivery robot 105 for conducting operations in accordance with the disclosure.

Navigation system hardware 315 can include various components of the delivery robot 105 such as, for example, a package handling element (arm, gripper, roller etc.), a steering mechanism, a propulsion system, a braking mechanism, and a Global Positioning System (GPS) system.

The memory 320, which is one example of a non-transitory computer-readable medium, may be used to store an operating system (OS) 340, a database 335, and various code modules such as a navigation system module 325 and an image processing module 330. The code modules are provided in the form of computer-executable instructions that are executed by the processor 305 to enable the navigation system 106 perform various operations in accordance with the disclosure. The navigation system module 325 can be executed for example, by the processor 305, to perform operations such as communicating with the building security system 151 for various purposes such as for producing a travel route and for abiding by rules and guidelines imposed by the building security system 151 upon the delivery robot 105.

Producing a travel route by the navigation system module 325 may be based on evaluating various type of images (such as images/video provided by the building security system 151) and using reference materials such as a reference topographic map, a reference terrain map, a reference graphical representation of the premises and the building 150, a reference digital rendering of the building 150, and/or a reference digital rendering of an object on the premises.

The navigation system module 325 may evaluate images in cooperation with an image processing module 330. The evaluation can include, for example, identifying a landmark on the premises of the building 150 and/or processing a reference image with respect to an image provided by the building security system 151 (comparing, editing, matching etc.)

The database 335 can be used to store reference material such as a reference image or reference information. Reference information can include details about one or more packages (address, recipient, etc.) and codes that may be presented by the delivery robot 105 to the gate camera 112 for entering the premises of the building 150.

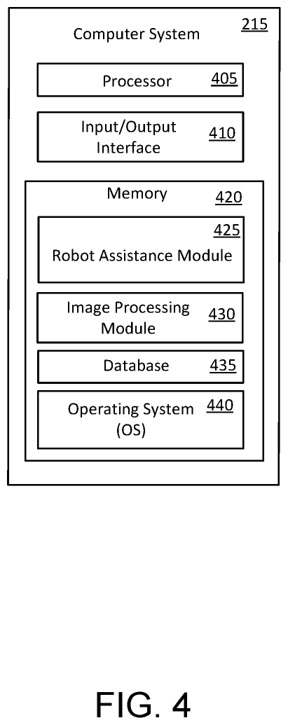

FIG. 4 shows some example components that may be included in the computer system 215 of the building security system 151 in accordance with an embodiment of the disclosure. The computer system 215 may include various components such as a processor 405, an input/output interface 410, and a memory 420. The input/output interface 410 can be used to allow various types of signals and information to pass into and/or out of the computer system 215. For example, the input/output interface 410 may be used to allows signals from the various security devices (such as the security camera 141, the security camera 154, and the gate camera 112) to be received by the computer system 215. The input/output interface 310 may also be used to communicate information from/to the gate operating system 111.

The memory 420, which is another example of a non-transitory computer-readable medium, may be used to store an operating system (OS) 440, a database 435, and various code modules such as a robot assistance module 425 and an image processing module 430. The code modules are provided in the form of computer-executable instructions that are executed by the processor 405 to enable the computer system 215 perform various operations in accordance with the disclosure. For example, the robot assistance module 425 can be executed by the processor 405 to perform operations such as providing assistance to the delivery robot 105 in accordance with the disclosure. For example, the computer system 215 may execute the robot assistance module 425 in order to provide to the delivery robot 105, items such as an obtained from the security camera 141 and/or the security camera 154, a topographic map of the premises, a terrain map of the premises, a graphical representation of the premises and the building 150, a reference digital rendering of the building 150, and/or a digital rendering of an object on the premises. The robot assistance module 425 may generate some of these items in cooperation with the image processing module 430.

The database 435 can be used to store materials such as details about one or more packages (address, recipient, etc.) that are expected to be delivered, and can also be used to store codes that may be presented by the delivery robot 105 to the gate camera 112 for entering the premises of the building 150. Some of the material stored in the database 435 may be unavailable elsewhere. Other material stored in the database 435 may be obtained by the computer system 215 from cloud storage 237 or from the database 335 of the delivery robot 105.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 320 and the memory 420, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a delivery robot, a first image of a premises of a building;
identifying, by the delivery robot, a first landmark in the first image;
detecting, by the delivery robot, the first landmark; and
delivering, by the delivery robot and based on detecting the first landmark, an item to the building

2. The method of claim 1, wherein the first image is captured by a camera mounted on the premises of the building, and wherein the first landmark is one of a pathway leading to the building or a portion of the building.

3. The method of claim 1, wherein identifying the first landmark in the first image comprises comparing the first image to one of a second image or a route map.

4. The method of claim 3, wherein the building is one of a residence or a business facility, and wherein the route map includes an identification of one or more obstacles to be circumvented by the delivery robot to reach a package drop-off spot.

5. The method of claim 3, wherein the second image is produced by an imaging device of the delivery robot.

6. The method of claim 3, wherein the route map is provided in a graphical representation of the premises, and wherein the graphical representation includes a path to be traversed by the delivery robot from a current location of the delivery robot to a package drop-off spot.

7. The method of claim 6, wherein the graphical representation further includes one or more areas on the premises to be circumvented by the delivery robot to reach the package drop-off spot.

8. A method comprising:
determining, by a delivery robot, a current location of the delivery robot;
receiving, by the delivery robot, an image captured by a camera mounted about the premises of a building; and
generating, by the delivery robot and based at least in part on the image, a route map of a terrain between the current location of the delivery robot and a package drop-off spot.

9. The method of claim 8, wherein the camera is mounted on one of a portion of the building or on a fixture located on the premises of the building, and wherein the image is transmitted to the delivery robot by a security system of the building.

10. The method of claim 8, wherein the image is received by the delivery robot subject to authorization by an authorization entity, and wherein the authorization entity places at least a first restriction upon a movement of the delivery robot on the premises of the building.

11. The method of claim 8, further comprising:
interpreting the route map, by the delivery robot and based on the image, to identify a path to be traversed by the delivery robot from the current location to the package drop-off spot.

12. The method of claim 8, further comprising:
displaying, by the delivery robot, an identifier; and
receiving, by the delivery robot and subject to authentication of the identifier by a security system of the building, the image.

13. The method of claim 12, wherein the identifier is a QR code provided on a package carried by the delivery robot for depositing at the package drop-off spot.

14. The method of claim 8, further comprising:
displaying, by the delivery robot, to the camera, an identifier; and
obtaining, by the delivery robot, a passage through one of a gate or a door that is opened by a security system of the building upon verification of the identifier by the security system.

15. A delivery robot comprising:
a propulsion system; and
a navigation system comprising:
a memory that stores computer-executable instructions; and
a processor configured to access the memory and execute the computer-executable instructions to at least:
receive a first image of the premises of a building;
identify a first landmark in the first image;
detect the first landmark; and
provide commands to the propulsion system to guide the delivery robot to a package drop-off spot on the premises of the building, the commands based on detecting the first landmark.

16. The delivery robot of claim 15, wherein the first image is captured by a camera mounted on the premises of the building, and wherein the first landmark is one of a pathway leading to the building or a portion of the building.

17. The delivery robot of claim 15, wherein the processor identifies the first landmark in the first image by comparing the first image to one of a second image or a route map.

18. The delivery robot of claim 17, wherein the building is one of a residence or a business facility, and wherein the route map includes an identification of one or more obstacles to be circumvented by the delivery robot to reach the package drop-off spot.

19. The delivery robot of claim 17, wherein the second image is produced by an imaging device of the delivery robot.

20. The delivery robot of claim 17, wherein the route map is provided in a graphical representation of the premises, and wherein the graphical representation includes a path to be traversed by the delivery robot from a current location of the delivery robot to the package drop-off spot.
